(19) United States
(12) Patent Application Publication
(10) Pub. No.: US 2026/0179092 A1
(43) Pub. Date: Jun. 25, 2026

(54) DEVICE AND METHOD FOR MANAGING ACCESS RIGHTS AND AUTHORIZATIONS

(71) Applicant: Commissariat à l'Energie Atomique et aux Energies Alternatives, Paris (FR)

(72) Inventors: Christine HENNEBERT, Grenoble (FR); Miguel-Angel FUENTES RAMIREZ, Grenoble (FR)

(21) Appl. No.: 19/424,359

(22) Filed: Dec. 18, 2025

(30) Foreign Application Priority Data
Dec. 19, 2024 (FR) 2414740

(51) Int. Cl. G06Q 20/40; G06Q 20/38

(52) U.S. Cl. CPC G06Q 20/401; G06Q 20/389

(57) ABSTRACT

The present description concerns a method of management of the access to the use of an automaton comprising the supply of an identification value, associated with a user, to a first device; the generation, by a secure circuit of the first device, of an account address based on a master key associated with the first device, on the identification value, and on a context value; the sending of a transaction to the account address in a blockchain; the validation or invalidation of the transaction by the blockchain based on the balance associated with the account address in the blockchain; and if the transaction is validated by the blockchain, the authorizing, by the first device, for the user to access the use the automaton.

### TECHNICAL FIELD

The present disclosure generally concerns the management of user access rights and authorizations to a device or equipment.

### PRIOR ART

An industrial site generally comprises a plurality of pieces of equipment, such as for example automatons and doors, to which it is necessary to control access, as well as authorizations to perform one or more operations and/or actions therein. In particular, these pieces of equipment are, for example, supplied by a supplier and used by users such as service providers or subcontractors. Generally, users of equipment of the industrial site originate from different entities. In addition, the operator of the industrial site may want for a user to have access to certain pieces of equipment only and, for example, only during a given time slot. The operator may further want for another user to have access to other pieces of equipment, or to the same pieces of equipment but for a different time slot. Access authorization to pieces of equipment of the industrial site is generally managed with electronic elements and/or components. It is important for the operator of the industrial site to have the possibility of managing equipment access rights and, for example, to add a degree of temporal granularity thereto.

The pieces of equipment being used by users coming from a plurality of entities, it is important to keep a record, or history, of equipment use. Indeed, in the case where the equipment becomes dysfunctional, causing an incident, for example, it is important to be able to trace back to the individual or entity having caused the malfunction. As an example, a malfunction may be caused by poor equipment settings, improper handling, poor training, etc.

It is thus important that, in the event of a malfunction, an audit by an authorized person enables to trace back the history of users having handled the defective equipment. However, for data protection purposes, it is equally important that this history, as well as the data related to each user, is not accessible to unauthorized third parties. In particular, it is important for the operator of the industrial site, equipment suppliers, the various entities employing the users, as well as any person with access, for example to a server where the histories would be stored, not to have access to the data related to the various users. There thus is a need for a solution to achieve these aims, which raise a technical issue.

### SUMMARY OF THE INVENTION

An embodiment provides a method of management, by a first device, of the access to the use of an automaton by a user, the method comprising:
the supply of an identification value, associated with the user, to the first device;
the generation, by a secure circuit of the first device, of an account address based on a master key associated with the first device, on the identification value, and on a context value;
the sending of a transaction, comprising a cost value, to the account address in a blockchain;
the validation or invalidation of the transaction, by the blockchain, based on the balance associated with the account address in the blockchain and on the cost value; and
if the transaction is validated by the blockchain, the authorizing, by the first device, for the user to access the use of the automaton.

According to an embodiment, the authorizing of the access to the use of the automaton comprises the activation of the automaton by the first device.

According to an embodiment, the transaction is validated by the blockchain when the account balance associated with the account address is greater than or equal to the cost value.

According to an embodiment, the transaction is an account-to-account transaction or a transaction towards a smart contract.

According to an embodiment, the generation of the account address comprises:
the generation of a first key by performing the derivation, by application by the secure circuit of a key derivation function associated with the Bitcoin Improvement Proposal 32 standard, of the master key according to a first index path;
the generation of a first public key by multiplying a first part of the leaf key with a generator point of the elliptic curve associated with the cryptographic system of the Bitcoin Improvement Proposal 32 standard; and
the generation of the account address by applying a hash function to the leaf public key.

According to an embodiment, the derivation of the master key according to the first index path comprises:
the application of a first index value, by the derivation function, the first index value being a constant value; and
following the application of the first index value, the application of a second index value, of a third index value, and of a fourth index value, the second and third index values being dependent on the identification value associated with the user and the fourth index value corresponding to the contextual value.

According to an embodiment, the second index value corresponds to the 31 least significant bits of the identification value and the third index value corresponds to the 31 most significant bits of the identification value.

According to an embodiment, the master key is a value over 2N bytes, the first key is a value over 2N bytes, and the first part of the first key corresponds to the first N bytes of the first key, N being an integer.

According to an embodiment, the context value corresponds to an encoding of the date of at least one day on which the user is authorized access to the use of the first device.

According to an embodiment, the context value further comprises an encoding of a time slot or of a geographic location associated with the first device.

According to an embodiment, the above method further comprises the provision, via an external device, of at least one coin on the account address in the blockchain by achieving:
the supply, by the first device, of a second public key and of a chain code associated with the first device;
the generation of the account address, by the external device, based on the second public key and on the chain code; and
the provision of at least one coin on the account address in the blockchain.

According to an embodiment, the second public key corresponds to a first part of a second key, the second key being obtained by the first device by derivation of the master key according to the first index value, and the external device is configured to generate the account address based on a key derivation, based on the second public key and on the chain code, and based on the second, third, and fourth index values.

According to an embodiment, the supply of the identification value to the first device is performed by the user, by presenting a user device having the identification value stored therein, the supply being achieved by near-field communication between the user device and the first device.

An embodiment provides a first device comprising a secure circuit having a seed value stored therein, the first device being configured to, as a response to the supply of an identification value by a user:
generate an account address based on a master key associated with the first device, on the identification value, and on a context value;
send a transaction, comprising a cost value, to the account address in a blockchain; and
if the transaction is validated by the blockchain, authorize the user to access the use of an automaton.

An embodiment provides a system comprising:
the above-described first device;
a blockchain configured to validate or invalidate the transaction sent by the first device, based on the balance associated with the account address in the blockchain and on the cost value; and
an external device, configured to generate the account address based on a second public key and on the chain code, supplied by the first device, on the identification value, and on a context value, and to provision at least one coin on the account balance at the account address in the blockchain.

According to an embodiment, the account address is generated by application of a key derivation function associated with the Bitcoin Improvement Proposal 32 standard.

### BRIEF DESCRIPTION OF THE DRAWINGS

These features and advantages, as well as others, will be described in detail in the following description of specific embodiments, which is provided by way of example and is not intended to be limiting, in connection with the accompanying drawings, in which:

FIG. 1 is a diagram illustrating an access system comprising different users with rights of access to an automaton of an industrial site;

FIG. 2 is a representation, in the form of different layers, of the operation of the digital blockchain technology;

FIG. 3 shows a user device and an equipment device configured for the implementation of an access authorization method, according to an embodiment of the present disclosure;

FIG. 4 illustrates the authentication of a user to a piece of equipment, according to an embodiment of the present disclosure;

FIG. 5 illustrates a hierarchical key derivation structure according to the BIP32 standard;

FIG. 6 illustrates the generation of an anonymized authentication value for a user, according to an embodiment of the present disclosure;

FIG. 7 illustrates an exchange between a device used by an operator of the industrial site and the equipment device, according to an embodiment of the present disclosure;

FIG. 8 illustrates the generation, by the device used by the operator, of an anonymized authentication value, according to an embodiment of the present disclosure; and

FIG. 9 illustrates the generation of a same anonymized authentication value by the device used by the operator and by the equipment device, according to an embodiment of the present disclosure.

### DESCRIPTION OF EMBODIMENTS

The same elements have been designated by the same references in the various figures. In particular, structural and/or functional elements common to the different embodiments may have the same references and may have identical structural, dimensional and material properties.

For the sake of clarity, only those steps and elements that are useful for understanding the described embodiments have been shown and have been described in detail. In particular, the blockchain digital technology, the key derivation methods, and the BIP32 (BitCoin Improvement Proposal 32) standard are known to those skilled in the art and are not described in detail.

Unless otherwise specified, when reference is made to two elements being connected to each other, this means directly connected without any intermediate elements other than conductors, and when reference is made to two elements being coupled to each other, this means that these two elements may be connected or may be connected via one or more other elements.

In the following description, where reference is made to absolute position qualifiers, such as the terms “front”, “back”, “top”, “bottom”, “left”, “right”, etc., or relative position qualifiers, such as the terms “top”, “bottom”, “upper”, “lower”, etc., or orientation qualifiers, such as “horizontal”, “vertical”, etc., reference is made unless otherwise specified to the orientation of the drawings.

Unless specified otherwise, the expressions “about”, “approximately”, “substantially”, and “in the order of” signify plus or minus 10% or 10°, preferably of plus or minus 5% or 5°.

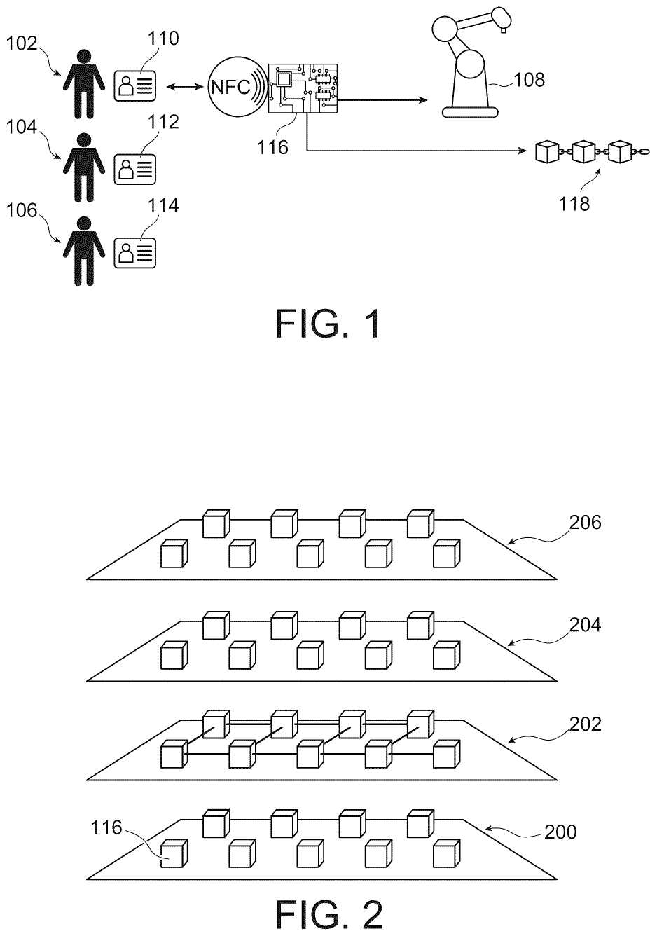

FIG. 1 is a diagram illustrating an access system comprising different users 102, 104, and 106 with rights of access to an automaton 108 of an industrial site. Users 102, 104, and 106 are, for example, employees of a same or different companies with a mission at the industrial site. In particular, users 102, 104, and 106 each hold a user device 110, 112, and 114, respectively. As an example, user devices 110, 112, and 114 are badges provided by an operator of the industrial site. As an example, user devices 110, 112, and 114 respectively give users 102, 104, and 106 access to the use of automaton 108. The use of the automaton comprises, for example, the activation of automaton 108 to unlock a door, supply power to a machine or another type of electronic circuit, deactivate an intrusion alarm system, etc. As an example, automaton 108 is an actuator allowing the opening of a door or the operation of an industrial machine. User devices 110, 112, and 114 each comprise, for example, a near-field communication (NFC) circuit.

Automaton 108 comprises, or is coupled to, one or more equipment devices 116. In particular, equipment device 116 comprises a near-field communication circuit. Equipment device 116 is further configured to activate or control automaton 108, for example via control signals. The industrial site comprises, for example, a plurality of automatons. Each automaton then comprises, or is coupled to, one or more equipment devices 116.

In order to use automaton 108, each user 102, 104, or 106 identifies to device 116 via their user device 110, 112, or 114. Equipment device 116 is then configured to authorize or not the use of automaton 108 based on this identification. As an example, equipment device 116 or automaton 108 comprises a time counter or timer (not shown). As an example, when equipment device 116 authorizes a user to access the use of automaton 108, the timer is triggered. When the timer reaches a threshold duration, in the order of one or more hours, equipment device 116 is configured to deny access to automaton 108 so that user 102 no longer has access thereto or can no longer operate it.

According to an embodiment, equipment device 116 is configured to perform a transaction, based on identification, towards a blockchain 118, implemented, for example, by a remote server coupled to equipment device 116 via a wired and/or wireless network. As an example, the blockchain is a so-called public blockchain, for example accessible from the Internet, and such as BitCoin-or Ethereum-type blockchains. In other examples, the blockchain is a consortium blockchain or a private blockchain.

FIG. 2 is a representation, in the form of different layers, of the operation of the blockchain digital technology.

Layer 200 represents the peer-to-peer network. Each block 201 represents a node of the network, for example a machine. The machines exchange information with one another in distributed fashion. In particular, in a blockchain, there is no central server, the information is replicated on each machine. As an example, each equipment device 116 is a node for blockchain 118.

Layer 202 represents a consensus protocol of the blockchain. The purpose of this layer is to achieve agreement between the machines. The consensus protocol allows machines to agree with one another on the information that they host in a shared and replicated ledger. The security of the protocol is implemented, for example, by a “coin,” such as a cryptocurrency for so-called permissionless blockchains or fuel for so-called permissioned blockchains.

An optional layer 204 represents the execution of smart contracts. Smart contracts are computer code executed in distributed fashion by all nodes taking part in the consensus. The execution of smart contracts is such that the result of the operations performed by each of the node is agreed upon by a majority of the nodes in order to be validated. Smart contracts are further configured to encode fungible or non-fungible tokens. As an example, fungible tokens are encoded by smart contracts such as ERC20 (Ethereum Request for Comment). As an example, non-fungible tokens are encoded by smart contracts such as ERC721 (Ethereum Request for Comment). Both ERC20 and ERC721 smart contracts are implemented on the Ethereum blockchain network. Other examples exist and are known to those skilled in the art. Tokens are a currency of exchange within a single community on a blockchain.

Layer 206 represents distributed applications developed to use the system resulting from layers 200, 202, and optionally 204. The applications enable to send transactions to the blockchain, either to activate a function of a smart contract or to transfer coins directly to layer 200. When a transaction is carried out towards a smart contract or when coins are transferred from one account of a blockchain user to another, it is ensured, for example, that the account balance of the issuer is positive and contains coins. A transaction towards a smart contract requires paying the cost of execution of the smart contract, which cost is called gas and is generally paid in coins.

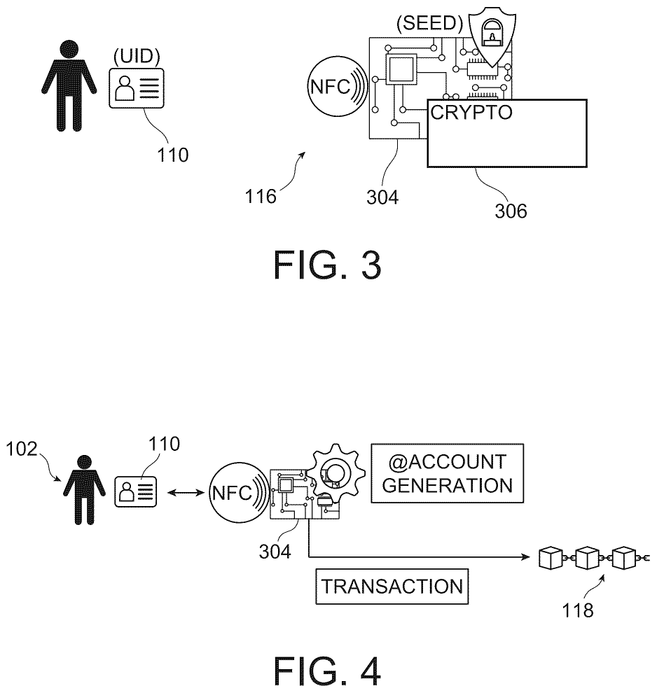

FIG. 3 shows user device 110 and equipment device 116 configured for the implementation of a method for authorizing access to the use of the automaton 108 of FIG. 1, according to an embodiment of the present disclosure. Device 110 comprises an identification value (UID), for example stored in a non-volatile memory comprised in user device 110. The identification value of a user device is unique, that is, two different user devices each comprise a different identification value. User device 110 is, for example, provided to a user, such as a worker at the industrial site, by the operator of the industrial site. The identification value of user device 110 is thus known to the operator of the industrial site. As an example, the identification value is stored in user device 110 in unencrypted form. As an example, the identification value is a value encoded over at least 31 bits. In another example, the identification value is a value encoded over less than 31 bits.

Equipment device 116 comprises a secure circuit 304 comprising a non-volatile memory in which a seed value is stored. The seed value is a secret value provisioned in circuit 304, for example by the supplier of equipment device 116. This value is in particular known neither by the operator of the industrial site, nor by user 102. Secure circuit 304 comprises, for example, a cryptographic circuit 306 (CRYPTO) configured for key derivation. According to an embodiment, the cryptographic circuit is configured to derive keys according to the BIP32 standard.

FIG. 4 illustrates the authentication of user 102 to equipment device 116, associated with automaton 108, according to an embodiment of the present disclosure.

According to an embodiment, when user 102 identifies via user device 110 to equipment device 116, secure circuit 304 is configured to generate an account address (@ACCOUNT GENERATION) based on the identification value and on the seed value. The generation is performed, for example, by cryptographic circuit 306. The secure circuit is then configured to send a transaction (TRANSACTION) to blockchain 118. The transaction is then recorded in blockchain 118 when the balance associated with the account address is positive. When the transaction is recorded, equipment device 116 is configured to authorize the use of automaton 108 by user 102. If the balance associated with the account address is zero, the transaction is rejected by blockchain 118 and equipment device 116 denies the use of automaton 108 by user 102.

According to an embodiment of the present disclosure, the consultation of blockchain 118 by a third party allow the latter neither to trace back to user 110, nor to trace back to equipment device 116, nor to trace back the actions performed by user 110 on automaton 108. User 110 thus acts in anonymized fashion on a digital system associated with the industrial site.

According to an embodiment, in order to grant rights of access to user 110, the operator of the industrial site is capable of constructing the account address based on the identification value and on a public key provided by equipment device 116. The operator of the industrial site is then able to provision the account balance at the account address in blockchain 118, so that user 110 can act on automaton 108.

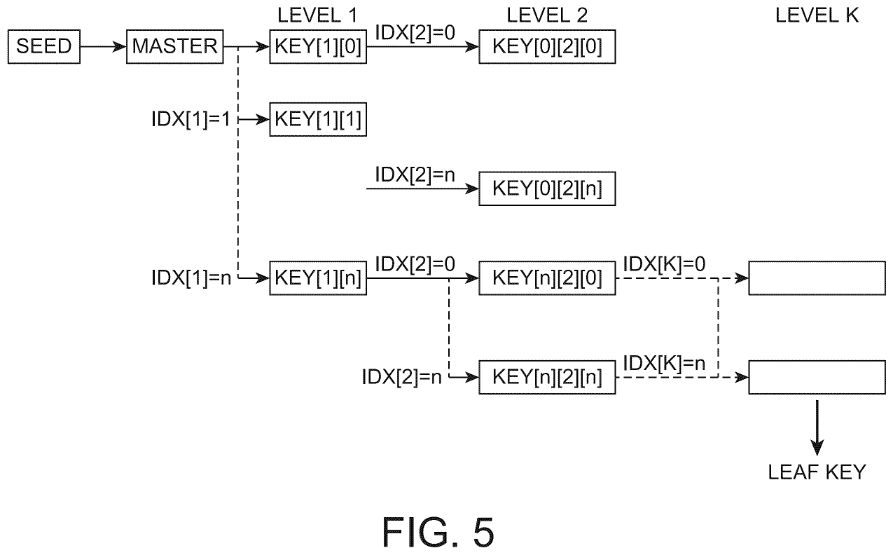

FIG. 5 illustrates a hierarchical key derivation structure according to the BIP32 standard. In particular, the key derivation illustrated in FIG. 5 is performed by cryptographic circuit 306 and results in the account address. In particular, an anonymized authenticator of user 110 is the account address issuing towards blockchain 118. In particular, the account address is constructed by using a deterministic hierarchical wallet structure, introduced in the BIP32 standard.

The seed value (SEED) is used for the generation of a master key (MASTER). The master key is also a secret value, stored in circuit 304. In particular, the master key cannot be extracted from secure circuit 304. The seed value and the master key are, for example, values encoded over 2N bytes, N being an integer value, for example equal to 32. A key derivation function is then applied to the master key. The key derivation function is applied to the master key based on an index path. The index path consists of a plurality of index values. Each index value corresponds to a derivation at one level. As an example, the index values are N-bit values smaller than or equal to 2^{N-1}.

As an example, in a first level (LEVEL 1), a first index value (IDX[1]) is applied to the master key. Depending on the value of the first index value, a plurality of derived key values are obtained. As an example, a key KEY[1][0] is obtained when the first index value is equal to a first value. Another key KEY[1][1] is obtained when the first index value is equal to a second value (IDX[1]=1). For a number n+1 of values that can be taken by the first index value (IDX[1]=0, . . . , IDX[1]=n), a number n+1 of keys (KEY[1][0], . . . , KEY[1][n]) is obtained. As an example, for a seed value and a master key of 64 bytes, the derived key values are also over 64 bytes.

As an example, in a second level (LEVEL 2), a second index value (IDX[2]) is applied to the keys derived at the first level. Depending on the value of the second index value, a plurality of derived key values are obtained. As an example, for each of the derived keys KEY[1][j], 0≤j≤n, a key KEY[j][2][0] is obtained when the second index value is equal to a first value IDX[2]=0. For each of the derived keys KEY[1][j], 0≤j≤n, a key KEY[j][2][1] is obtained when the second index value is equal to a second value IDX[2]=1. For a number n+1 of values that can be taken by the second index value (IDX[2]=0, . . . , IDX[2]=n), a number (n+1)² of keys is obtained from the n+1 values of keys derived at the first level. For example, the values of keys derived at the second level are also over 64 bytes.

The keys are successively derived, up to a level K (LEVEL K), on which a K-th index value (IDX[K]) is applied. As an example, the K-th index value can take n+1 different values (IDX[K]=0, . . . , IDX[K]=n) and each key derived on the K-1-th level can thus be derived into n+1 new keys on the K-th level. In particular, each key on the K-th level can be derived from the master key from a single derivation path. A derivation path then corresponds to the sequence, or series, comprising the index values used for the obtaining of said key on the K-th level.

According to an embodiment, the account address is generated by cryptographic circuit 306 during the identification of user 102 via user device 110 by applying a derivation path to the master key constructed from the seed value. As an example, the account address is obtained by derivation of the master key. The first derivation is performed based on a constant index value, smaller than or equal to 2³¹, for example value 0xCAFE, or any other value. The obtained key is then a level-1 key and is equal to the derivation according to the master/0xCAFE index path, where symbol/designates the derivation and where “master” corresponds to the value of the master key. A derivation on a second level is performed based on an index value depending on the identification value of user device 110.

As an example, on the second derivation level, the index value used corresponds to the 31 least significant bits (UID(LSB)) of the identification value. The index path is then equal to master/0xCAFE/UID(LSB). As an example, on a third derivation level, the index value used corresponds to the 31 most significant bits (UID(MSB)) of the identification value. The index path is then equal to master/0xCAFE/UID(LSB)/UID(MSB). In the case where the length of the identification value is smaller than 31 bits, the 31 most significant bits are by convention all equal to 0. On a fourth derivation level, the index value for the derivation includes contextual information. As an example, the index value used on the fourth level corresponds to the current date, for example in a DDMMYYYY format concatenating the current date, month, and year, the date corresponding to the date for which the operator of the industrial site wishes to authorize access to automaton 108 for user 102. The key derived on the fourth level is then, for example, derived according to path master/0xCAFE/UID(LSB)/UID(MSB)/DDMMYYYY. In other examples, the index value used on the fourth level integrates a finer or broader time granularity than only the day-month-year format. As an example, the index value used on the fourth level integrates a time slot for a given date. In this case, the operator of the industrial site wants user 102 to have access to automaton 108 only during this time slot. In another example, the index value used on the fourth level corresponds to the concatenation of a plurality of days. In this case, the operator of the industrial site for example wants user 102 to have access to automaton 108 for a plurality of consecutive days.

As an example, and optionally, an additional derivation is performed on a fifth level. As an example, this additional derivation is performed based on an index value comprising additional contextual information, such as for example the location coordinates, such as GPS (Global Positioning System) coordinates, of the industrial site or of automaton 108. The key resulting from the application of the index path on the four or five levels is called leaf key (LEAF KEY) hereafter.

The leaf key is, for example, a key over 2N bytes, for example 64 bytes. The first N bytes of the leaf key correspond, for example, to a private key, called private leaf key (LEAF_SK) hereafter. The last N bytes correspond, for example, to a chain code, called leaf chain code hereafter.

A public key, called leaf public key (LEAF_PK) hereafter and associated with the private leaf key, corresponds to the multiplication in an elliptic curve cryptographic system of the private leaf key with the generator point of the cryptographic system. In particular, the cryptographic system is the system on the elliptic curve known to those skilled in the art as secp256k1.

The account address, called leaf account (LEAF ACCOUNT) address, is then obtained by hashing of the leaf public key. As an example, when blockchain 118 is an Ethereum-type blockchain, the leaf account address corresponds to the 20 least significant bytes of the output of a hash function taking the leaf public key as an input. As an example, the hash function used is the function known to those skilled in the art as keccak256. In another example, when blockchain 118 is of Bitcoin type, the leaf account address is constructed as being the output of the hash function known as H160, taking the leaf public key as an input, to which is applied a base-58 encoding, followed by the addition of a cyclic redundancy check (CRC) code.

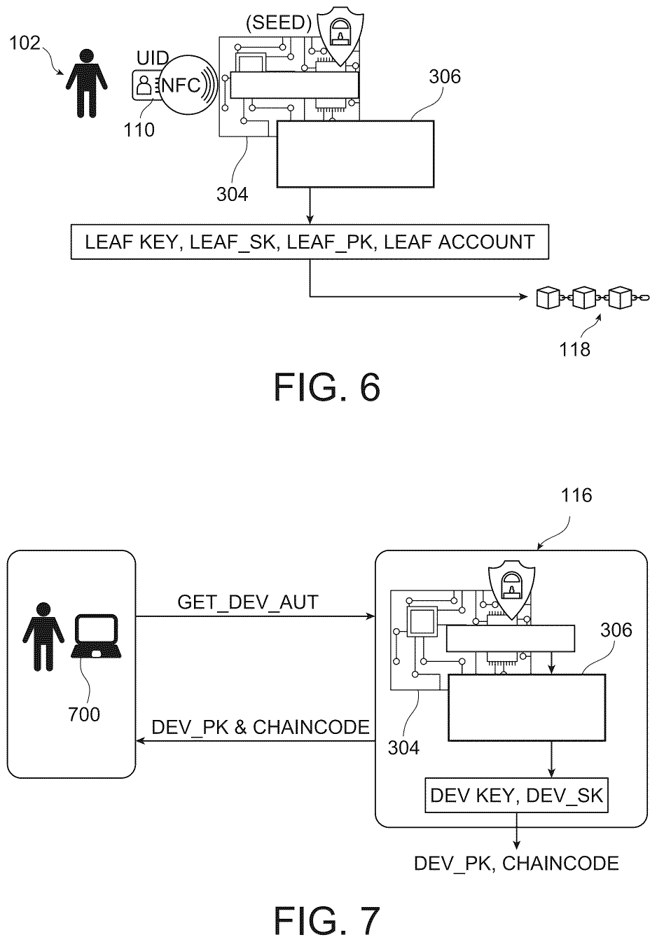

FIG. 6 illustrates the generation of an anonymized authentication value for a user, according to an embodiment of the present disclosure. In particular, the anonymized authentication value corresponds to the leaf account address generated by secure circuit 304, more specifically cryptographic circuit 306, such as described in relation with FIG. 5. In particular, the index path used for the generation of the leaf key is, for example, master/0xCAFE/UID(LSB)/UID(MSB)/JJMMAAA. In other examples, the first index is equal to a constant smaller than 2³¹, different from 0xCAFE. As an example, the first index value comprises hexadecimal characters. As an example, the fourth index value comprises a finer or broader granularity than a date in DDMMYYYY format and comprises, for example, a time slot. As an example, the index path comprises a fifth index, comprising an additional contextual indication, for example the GPS coordinates of the industrial site or of automaton 108.

The leaf account address is then used, by equipment device 116, to send a transaction to blockchain 118. Depending on the technology of blockchain 118, the transaction is, for example, an account-to-account value transaction or a smart contract transaction. The transaction performed requires, for example, for the balance of the issuer, that is, of the leaf account, to be positive. In particular, the transaction sent to the leaf account address in blockchain 118 comprises an indication of a cost value. If the balance of the leaf account comprises enough coins to pay for the cost value, and the gas if necessary, the transaction is validated by blockchain 118, otherwise it is rejected.

According to an embodiment, the operator of the industrial site is capable of crediting the addresses of the accounts of the various users operating on the site. In order to ensure the anonymization of actions, the operator of the industrial site is capable of constructing the leaf account addresses of the various users in order to credit them.

FIG. 7 illustrates an exchange between a device used by an operator of the industrial site and equipment device 116, according to an embodiment of the present disclosure. In particular, the operator of the industrial site does not have access to the seed value comprised in secure circuit 304 and thus cannot directly generate the anonymized authenticator. Indeed, the seed value cannot be extracted from secure circuit 304. Further, the operator of the industrial site further does not have access to the keys generated by cryptographic circuit 306 and by application of the derivation function. However, index values such as the identification value as well as the contextual information used for the index path are public values.

According to an embodiment, the operator of the industrial site transmits a request (GET_DEV_AUT) to device 116 and via a device 700. As an example, device 700 is a computer, coupled by a wired and/or wireless network to equipment device 116 and to blockchain 118. As a response to this request, equipment device 116, and more particularly cryptographic circuit 306, is then configured to generate a derivation path (PATH) corresponding to the derivation of the master key based on the first index value. The first index value is, in particular, a constant value. In the examples of the present description, this value is arbitrarily set to 0xCAFE. In particular, the key derivation function used is the derivation function associated with the BIP32 standard and is the same as that used for the generation of the leaf keys described in relation with FIG. 6. The application of the master/0xCAFE derivation path to the seed value then results in an extended key DEV KEY, over 2N bytes. The first N bytes correspond, for example, to a private key DEV_SK and the last N bytes, for example, to a chain code CHAINCODE. Cryptographic circuit 306 is then configured to calculate a public key DEV_PK associated with private key DEV_SK. In particular, the public key is equal to the multiplication on an elliptic curve of private key DEV_SK with the generator point of the elliptic curve of the secp256k1 cryptographic system.

Equipment device 116 is then configured to return, to device 700, public key DEV_PK and chain code (DEV_PK; CHAINCODE). In particular, the value of public key DEV_PK depends on the seed value of secure device 304. Key DEV KEY and public key DEV_PK are therefore unique. In other words, for two different equipment devices, keys DEV KEY and DEV_PK and private key DEV_SK differ.

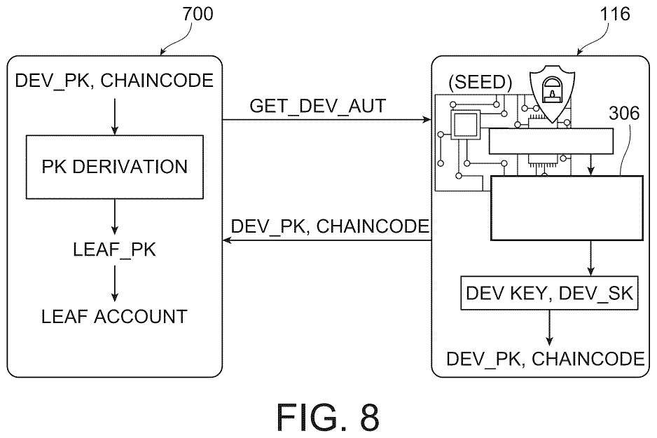

FIG. 8 illustrates the generation, by device 700, of an anonymized authentication value, according to an embodiment of the present disclosure. In particular, device 700 comprises an application 800 (PK DERIVATION) of key derivation according to the BIP32 standard. In particular, this key derivation is performed from a public key and a chain code. On reception of public key DEV_PK and of the chain code, device 700, via the key derivation application and the application of a hash function, is configured to generate the leaf account address, identical to that generated by device 116 when user 110 presents their user device 102.

Cryptographic key derivation functions according to the BIP32 standard are such that derivation from a public key has the same result as derivation from the associated private key, multiplied by the generator point of the secp256k1 elliptic curve.

When the operator of the industrial site wants to generate the leaf account address for user 102 and for a given day or time slot, they provide device 700 with the identification value contained in user device 110 as well as contextual information comprising, for example, the current date and/or the time slot during which access will be authorized. Device 700 further receives, from equipment device 116, the public key DEV_PK and the chain code CHAINCODE retrieved as a response to the request from the operator of the industrial site, as described in relation with FIG. 7. Device 700, via application 800, applies a key derivation path D/UID(LSB)/UID(MSB)/JJMMAAA, where D corresponds to the concatenation of public key DEV_PK and of the chain code. In other words, application 800 is configured to construct a derivation path, starting from D and with as a first index the second index value used by circuit 306, that is, the 31 least significant bits of the identification value, as a second index the third index value used by circuit 306, that is, the 31 most significant bits of the identification value, and as a third index the fourth index value used by circuit 306, that is, the contextual information. As an example, other index values, corresponding for example to contextual location indications, are applied. In particular, the sequence of index values used by application 800 corresponds exactly to the sequence, starting from the second index value, used by cryptographic circuit 306 on generation of the leaf key, such as described in relation with FIG. 5. The leaf public key (LEAF PK) then corresponds to the first N bytes of the leaf key. In particular, the leaf public key corresponds to the leaf public key generated by secure circuit 304, as described in relation with FIG. 6. The leaf account address is then obtained by hashing of the leaf public key, according to the same hash as that implemented by secure circuit 304 and such as described in relation with FIG. 6. As an example, when blockchain 118 is an Ethereum-type blockchain, the leaf account address corresponds to the 20 least significant bytes of the output of a hash function taking as an input the leaf public key. As an example, the hash function used is the function known to those skilled in the art as keccak256. In another example, when blockchain 118 is of Bitcoin type, the leaf account address is constructed as being the output of the hash function known as H160, taking as an input the leaf public key, to which is applied a base-58 encoding, followed by the addition of a cyclic redundancy check (CRC) code. This same account address will be generated by cryptographic circuit 306 on reception of the identification value of device 110. In particular, the two addresses, that generated by application 800 and that generated by cryptographic circuit 306, are identical if the contextual information matches. As an example, if the operator of the industrial site indicates a first date when the leaf address is generated by application 800 and user 102 presents their user device 110 to equipment device 116 on another date, the index values comprising the contextual information will differ and the generated leaf addresses will be different.

The operator of the industrial site thus has the ability to generate, via device 700 and application 800, a leaf account address for each user of each of the automatons on the site, and this, according to a predefined time granularity.

According to an embodiment, the operator of the industrial site credits the leaf account with coins to authorize its use. For this purpose, the operator of the industrial site sends a transaction, comprising a value, that is, a positive amount of coins, to the leaf account address generated by application 800 in blockchain 118. As an example, the number of transmitted coins depends on a use intended by the site operator for user 102. As an example, the number of coins corresponds to the number of connections authorized by user 102 to automaton 108. In another example, the number of coins corresponds to a duration, for example a number of hours, during which user 102 is authorized to use automaton 108. When the balance of the leaf account is zero, user 102 no longer has access to automaton 108. Blockchain 118 is then configured so that no transaction is free in terms of coins. Coins are used, for example, to pay for value, or fuel, and/or gas.

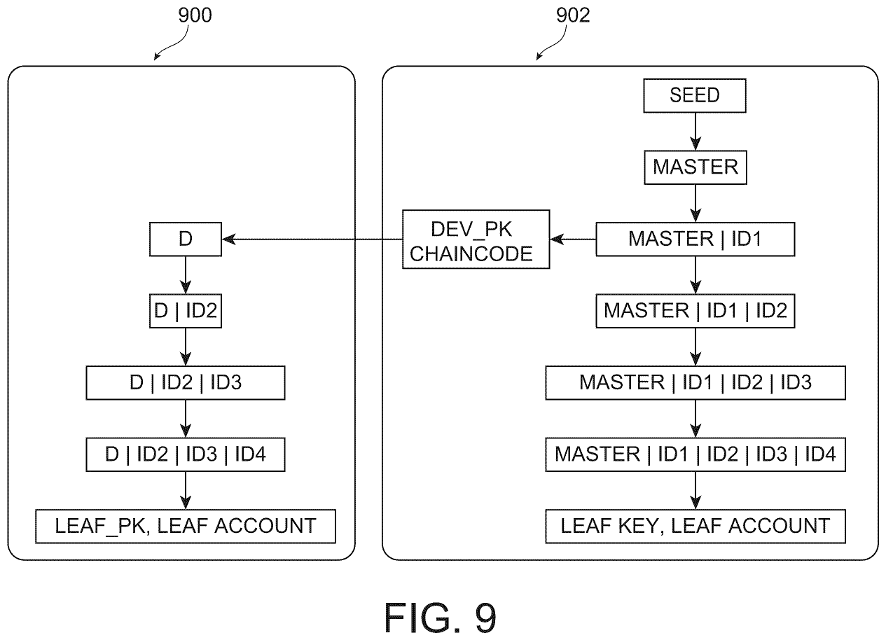

FIG. 9 illustrates the generation of a same anonymized authentication value by the device 700 used by the operator and by equipment device 116, in particular by cryptographic circuit 306, according to an embodiment of the present disclosure.

Block 900 illustrates the generation of the leaf account address for user 102, on the side of the operator of the industrial site, via device 700, and in particular application 800. A block 902 illustrates the generation of public key DEV_PK, as a response to a request from the user, as well as the generation of the leaf account address, as a result of the identification of user 102.

As described in relation with FIG. 7, when the operator of the industrial site wants to provision the user's account in order to grant them access to automaton 108, they need to generate the leaf account address for user 102 in order to credit their account balance on blockchain 118.

Device 700 is then configured to send a request to equipment device 116. Secure circuit 304, and more specifically cryptographic circuit 306, then generates the public key DEV_PK and the chain code specific to equipment device 116. In particular, extended key DEV KEY is first generated, by application of index path MASTER/ID1, where ID1 is the first index value, here described as being equal to 0xCAFE but which can take any value smaller than 2³¹. In an example, this first index value is identical for each of equipment devices 116. In another example, the first index value differs from one device 116 to the other. Private key DEV_SK, corresponding for example to the first N bytes of extended key DEV KEY, is then multiplied by the generator point of the elliptic curve associated with the secp256k1 cryptographic system. Public key DEV_PK results from this multiplication. Public key DEV_PK and the chain code CHAINCODE corresponding, for example, to the last N bytes of extended key DEV KEY are provided, as a response to the request, to device 700.

The site operator further supplies the identification value of the user 102 to whom access is desired to be granted to automaton 108, as well as one or more pieces of contextual information, such as the date of the day on which access is requested, the time slot, etc. Based on this information, device 700 generates an index path (PATH2). As an example, the first index value of this path ID2 is equal to the N least significant bits of the identification value of user 102. As an example, the second index value of this path ID3 is equal to the N most significant bits of the identification value of user 102. As an example, the third index value of this path ID3 corresponds to contextual information, for example in a DDMMYYYY date format.

Device 700, via the execution of application 800, then successively derives the concatenation D of public key DEV_PK and of the chain code provided by device 116 by index value ID2, then by index value ID3, and then by index value ID4. The derivation paths followed by application 800 are consecutively D/ID2, D/ID2/ID3, and D/ID2/ID3/ID4. The key resulting from the derivation path implemented by application 800 corresponds to leaf key LEAF KEY, having its first N bytes corresponding, for example, to public key LEAF_PK. Leaf address LEAF ACCOUNT is then generated by application of the hash function, as described in relation with FIG. 6.

When leaf account address LEAF ACCOUNT is generated on the side of the operator of the industrial site, the latter performs a transaction to provision the balance at the leaf account address on blockchain 118.

When user 102 wants to intervene or manipulate automaton 108, they identify, via their user device 110, to equipment device 116. During identification, the identification value contained in user device 110 is transmitted, for example by near-field communication, to equipment device 116. The account address is then generated, by cryptographic circuit 306, by application of an index path (PATH1). The derivation is performed from the master key MASTER constructed from seed value SEED. The index path used by cryptographic circuit 306 corresponds to the derivation according to a first index value ID1, equal to a constant, for example 0xCAFE. The index values then applied correspond to those applied by device 700, that is, value ID2, corresponding for example to the N least significant bits of the identification value, then value ID3, corresponding for example to the N most significant bits of the identification value, and then value ID4, corresponding to the contextual information. Application 800 and equipment device 116 are therefore configured to generate index value ID4 in the same format. For example, when index value ID4 corresponds to the current date in the DDMMYYYY format, equipment device 116 comprises a clock and index value ID4 is the current date in the DDMMYYYY format. Index value ID4 is therefore not a fixed value and depends on the context, for example, depends on the day on which user 102 identifies. The derivation of the master key by the sequence of indexes ID1, ID2, ID3, and ID4 then results in leaf key LEAF KEY. Leaf account address LEAF ACCOUNT then corresponds to the application of the hash function to the multiplication of the first N bytes of the leaf key by the generator point of the elliptic curve of the secp256k1 cryptographic system.

Access to automaton 108 is then authorized by equipment device 116 only if the balance of the leaf account in the blockchain is positive and sufficient.

When user 102 identifies to equipment device 116, via their user device 110, equipment device 116 generates leaf key LEAF KEY and then leaf account address LEAF ACCOUNT. Equipment device 116 then issues a transaction from the leaf account address, digitally signed with the leaf key. When the leaf account balance is zero, or does not contain enough coins to pay the amount indicated in the transaction and/or the fuel for the execution of the operation, the transaction is canceled. Equipment device 116 is then configured to reject the access request from user 102.

As an example, in the case where blockchain 118 is configured to implement smart contracts, each transaction includes a gas cost paid in coins for the operation targeted in the smart contract. This cost corresponds to gas. In particular, the gas corresponds to the cost incurred by blockchain 118 to verify the transaction. The fuel is then paid for in coins. If the leaf account balance does not contain enough coins to pay for the gas, the transaction is canceled and user 102 is denied access to automaton 108.

As an example, if blockchain 118 is configured to perform account-to-account value transfer operations, the transaction is validated if the leaf account balance is positive and sufficient. As an example, for each transaction validated on the leaf account, the leaf account balance is debited of one or more coins.

An authorized person is able to read the addresses of the accounts issuing transactions in the blockchain over an audited period of time. As an example, the authorized person reviews a schedule containing information on the users involved, the public keys DEV KEY of the equipment devices, the user identification values, and information on the day or time slot during which the audit takes place. The authorized person then repeats the method described in relation with FIG. 8 to construct the addresses of the accounts to be credited. Once the account addresses have been reconstructed, the authorized person checks, for example, whether they match. In particular, the authorized person checks which identification value an account address that involved in a malfunction corresponds to. Since the operator of the industrial site knows the identification values associated with the users, it is then possible for the authorized person to trace back to a user.

An advantage of the described embodiments is that the blockchain does not comprise a history of access rights having been authorized or not. The implemented system does not comprise a variable in the blockchain encoding whether authorization is granted or not. Indeed, transactions sent by equipment devices are not carried out according to a request-response system. The transaction is simply validated if the issuer account balance is positive and rejected otherwise.

Another advantage of the described embodiments is that consulting the blockchain enables neither to trace back to the user's identity, nor to trace back to the equipment device, nor to trace back the actions performed by the user on automaton 108.

Another advantage of the embodiments is that access rights are granted based on contextual information, including, for example, temporal granularity. This contextual information, encoded in one or more index values for key derivation, enables to finely manage access authorizations. Authorizations are for example granted for a given period and associated with an equipment device. Consulting the blockchain does not enable to discover this contextual information.

Various embodiments and variants have been described. Those skilled in the art will understand that certain features of these various embodiments and variants could be combined, and other variants will be apparent to those skilled in the art. In particular, as for the type of blockchain used, it can be a public, private, or consortium blockchain, implementing smart contract and/or account-to-account transactions. Similarly, the index values used for key derivation may vary, in particular as to the first index value ID1, although it is here described as being value 0xCAFE, this value is only an example and any other value may be used. Similarly, although the disclosure is based on an example of an industrial site, the described access rights management method applies to any other example.

Finally, the practical implementation of the described embodiments and variants is within the abilities of those skilled in the art based on the functional indications given hereabove.

1. Method of management, by a first device, of the access to the use of an automaton by a user, the method comprising:
the supply of an identification value, associated with the user, to the first device;
the generation, by a secure circuit of the first device, of an account address based on a master key associated with the first device, on the identification value, and on a context value;
the sending of a transaction, comprising a cost value, to the account address in a blockchain;
the validation or invalidation of the transaction by the blockchain based on the balance associated with the account address in the blockchain and on the cost value; and
if the transaction is validated by the blockchain, the authorizing, by the first device, for the user to access the use of the automaton.

2. Method according to claim 1, wherein the authorizing of the access to the use of the automaton comprises the activation of the automaton by the first device.

3. Method according to claim 1, wherein the transaction is validated by the blockchain when the account balance associated with the account address is greater than or equal to the cost value.

4. Method according to claim 1, wherein the transaction is an account-to-account transaction or a transaction towards a smart contract.

5. Method according to claim 1, wherein the generation of the account address comprises:
the generation of a first key by performing the derivation, by application by the secure circuit of a key derivation function associated with the Bitcoin Improvement Proposal 32 standard, of the master key according to a first index path (PATH1);
the generation of a first public key (LEAF_PK) by multiplying a first part of the first key with a generator point of the elliptic curve associated with the cryptographic system of the Bitcoin Improvement Proposal 32 standard; and
the generation of the account address by applying a hash function to the first public key.

6. Method according to claim 5, wherein the derivation of the master key according to the first index path comprises:
the application of a first index value by the derivation function, the first index value being a constant value; and
following the application of the first index value, the application of a second index value, of a third index value, and of a fourth index value (ID4), the second and third index values being dependent on the identification value associated with the user and the fourth index value corresponding to the contextual value.

7. Method according to claim 6, wherein the second index value corresponds to the 31 least significant bits of the identification value and the third index value corresponds to the 31 most significant bits of the identification value.

8. Method according to claim 5, wherein the master key is a value over 2N bytes, the first key is a value over 2N bytes, and the first part of the first key corresponds to the first N bytes of the first key, N being an integer.

9. Method according to claim 1, wherein the context value corresponds to an encoding of the date of at least one day on which access to the use of the first device is authorized for the user.

10. Method according to claim 9, wherein the context value further comprises an encoding of a time slot or of a geographic location associated with the first device.

11. Method according to claim 1, further comprising the provision, via an external device, at least one coin on the account address in the blockchain by achieving:
the supply, by the first device, of a second public key and of a chain code associated with the first device;
the generation of the account address, by the external device, based on the second public key and on the chain code; and
the provision of at least one coin on the account address in the blockchain.

12. Method according to claim 11 as dependent on claim 5, wherein the second public key corresponds to a first part of a second key, the second key being obtained by the first device by derivation of the master key according to the first index value, and wherein the external device is configured to generate the account address based on a key derivation, based on the second public key and on the chain code and based on the second, third, and fourth index values.

13. Method according to claim 1, wherein the supply of the identification value to the first device is performed by the user, by presenting a user device having the identification value stored therein, the supply being achieved by near-field communication between the user device and the first device.

14. First device comprising a secure circuit having a seed value (SEED) stored therein, the first device being configured to, as a response to the supply of an identification value by a user:
generate an account address based on a master key associated with the first device, on the identification value, and on a context value;
send a transaction, comprising a cost value, to the account address in a blockchain; and
if the transaction is validated by the blockchain, authorize access for the user to the use of an automaton.

15. System comprising:
the first device according to claim 14;
a blockchain configured to validate or invalidate the transaction sent by the first device, based on the balance associated with the account address in the blockchain and on the cost value; and
an external device configured to generate the account address based on a second public key and on the chain code, supplied by the first device, on the identification value, and on a context value, and to provision at least one coin on the account balance at the account address in the blockchain.

16. System according to claim 15, wherein the account address is generated by application of a key derivation function associated with the BitCoin Improvement Proposal 32 standard.
